(19) United States
(12) Patent Application Publication
(10) Pub. No.: US 2010/0071614 A1
(43) Pub. Date: Mar. 25, 2010

(54) Fluid distribution apparatus and method of forming the same

(75) Inventors: John Mariner, Avon Lake, OH (US); Marc Schacpkens, Medina, OH (US); David Michael Rusinko, Parma Heights, OH (US)

Correspondence Address: Momentive Performance Materials Inc., c/o McDonald Hopkins LLC, 600 Superior Avenue, E., Suite 2100, Cleveland, OH, 44114-2653, US

(73) Assignee: Momentive Performance Materials, Inc.

(21) Appl. No.: 12/284,418

(22) Filed: Sep. 22, 2008

(51) Int. Cl. B05C 9/14; B05D 1/38

(52) U.S. Cl. 118/50; 427/264

(57) ABSTRACT

A fluid distribution apparatus and method of forming such an apparatus is provided. A fluid distribution apparatus includes a body, a plenum, an inlet, and an outlet. The body is formed from at least one of a nitride, carbide, carbonitride, oxynitride of elements comprising boron, aluminum, silicon, gallium, refractory hard metals, transition metals, and rare earth metals, or complexes or combinations thereof. The plenum is positioned within the body. The inlet passes through a first portion of the body and is in fluid communication with the plenum, and the outlet passes through a second portion of the body and is also in fluid communication with the plenum.

### FIELD OF INVENTION

The present invention relates generally to a fluid distribution apparatus and method of forming such apparatus from materials resistant to the corrosive and deteriorative nature of highly reactive materials.

### BACKGROUND

In certain industries it is necessary to handle highly reactive gases and liquids. Such gases and liquids are often distributed or dispensed during industrial processes and applications. Dispensing articles used in handling such highly reactive gases and liquids often rapidly corrode and deteriorate when contacting the gases and liquids. Thus, the service life of such dispensing articles is dependant on its ability to resist corrosion and deterioration by highly reactive gases and liquids.

For example, in semiconductor wafer processing, gases are often distributed across a wafer surface to make one or more layers of a semiconductor device. Such gases may include ammonia, silane, and various metal organic vapors. When heated, such gases may dissociate or crack resulting in, for example, hot hydrogen and other species with highly corrosive properties.

In another example, metals are particularly difficult to handle in both liquid and gas stages because of their reactivity, temperature, and permeation properties. In the thin film solar cell industry it is common to handle copper, indium, gallium, and selenium vapors and gases in the fabrication of solar cells. All of these materials have a corrosive impact on the material used for fluid distribution systems used to handle such materials.

The metal coatings industry uses liquid and gaseous metals to form layers on other metals. A dispensing article positioned above a metal sheet for depositing liquid and gaseous metals must resist the highly reactive nature of liquid and gaseous metals. When articles for dispensing metals are formed from materials that react with liquid or gaseous metal, rapid corrosion and deterioration compromises the structural integrity of the material and causes rapid failure of the article. In addition to the need for a dispensing article to resists the highly reactive nature of liquid and gaseous metals, an article must also withstand the high temperatures required to dispense such metals. An article for dispensing gaseous or liquid metal also must have a sufficient density to withstand the permeation of gaseous metal through the walls of the article.

Because of these challenges, dispensing articles typically have a very short service life and are essentially disposable, which leads to inefficient and cumbersome, processes that are prone to errors. There exists a need for a novel apparatus and methods for forming such apparatus for handling highly reactive materials, including but not limited to liquid or gaseous aluminum, that increase service life of the apparatus.

### SUMMARY OF INVENTION

A fluid distribution apparatus and method of forming such an apparatus is provided. A fluid distribution apparatus includes a body, a plenum, an inlet, and an outlet. The body is formed from at least one of a nitride, carbide, carbonitride, oxynitride of elements comprising boron, aluminum, silicon, gallium, refractory hard metals, transition metals, and rare earth metals, or complexes or combinations thereof. The plenum is positioned within the body. The inlet passes through a first portion of the body and is in fluid communication with the plenum, and the outlet passes through a second portion of the body and is also in fluid communication with the plenum.

A method for forming a fluid distribution apparatus includes providing a substrate and depositing a first layer onto the substrate. The first layer is formed for at least one of a nitride, carbide, carbonitride, oxynitride of elements selected from the group of boron, aluminum, silicon, gallium, refractory hard metals, transition metals, and rare earth metals, or complexes or combinations of such materials. At least one hole is formed through at least a portion of the first layer and substrate. A second layer is deposited onto at least a portion of the remaining first layer and exposed substrate. At least one hole is formed through the first and second layers to provide fluid access to the substrate. Substrate material is removed from the hole by placing the partially-formed apparatus in an elevated temperature environment to form a fluid distribution apparatus.

### BRIEF DESCRIPTION OF THE DRAWINGS

The accompanying drawings, which are incorporated in and constitute a part of the specification, illustrate various aspects of the preferred embodiments.

FIG. 1 illustrates a cross-sectional view of a partially-formed fluid distribution apparatus;

FIG. 2 illustrates a cross-sectional view of a partially-formed fluid distribution apparatus;

FIG. 3 illustrates a cross-sectional view of a partially-formed fluid distribution apparatus;

FIG. 4 illustrates a cross-sectional view of a partially-formed fluid distribution apparatus;

FIG. 5 illustrates a bottom view of a fluid distribution apparatus;

FIG. 6 illustrates a bottom view of a fluid distribution apparatus;

FIG. 7 illustrates a cross-sectional view of a partially-formed fluid distribution apparatus;

FIG. 8 illustrates a cross-sectional view of a fluid distribution apparatus;

FIG. 9 illustrates a partial perspective cross-sectional view of a fluid distribution apparatus;

FIG. 10 illustrates a partial perspective view of a fluid distribution apparatus;

FIG. 11 illustrates a partial perspective cross-sectional view of a fluid distribution apparatus;

FIG. 12 illustrates a partial perspective view of a partially-formed fluid distribution apparatus;

FIG. 13 illustrates a partial perspective detailed view of the partially-formed fluid distribution apparatus of FIG. 12;

FIG. 14 illustrates a partial perspective detailed view of a partially-formed fluid distribution apparatus;

FIG. 15 illustrates a partial perspective detailed view of a partially-formed fluid distribution apparatus;

FIG. 16 illustrates a partial perspective detailed view of a fluid distribution apparatus;

FIG. 17 illustrates a partial perspective view of a fluid distribution apparatus;

FIG. 18 illustrates a partial perspective cross-sectional view of a fluid distribution apparatus;

FIG. 19 illustrates a partial perspective cross-sectional detail view of a fluid distribution apparatus of FIG. 18; and

FIG. 20 illustrates a partial perspective cross-sectional detail view of a fluid distribution apparatus of FIG. 18.

### DETAILED DESCRIPTION OF THE PREFERRED EMBODIMENTS

Throughout this specification, materials will be described as fluids, in a fluid state, in a fluid phase, or the like. It will be understood that the use of the term “fluid” or phrases including the term “fluid” will include the liquid, gas, and vapor states of the material.

In an embodiment of an apparatus for handling highly reactive fluids, an article with a relatively complex shape or geometry is provided to distribute or deposit the highly reactive fluid onto a surface. Such a fluid distribution apparatus may include at least one inlet, at least one outlet, and at least one plenum. The plenum may be generally a chamber, cavity, fluid path, or other such fluid containing structure located within the fluid distribution apparatus. The plenum may be generally arranged so that fluid contained in the plenum may be subjected to positive pressures. The inlet may generally provide an opening in the apparatus through which the plenum may be accessed to provide fluid to the plenum, remove fluid from the plenum, provide positive pressure to the plenum, or the like. The outlet provides an opening through which the fluid contained in the plenum may be distributed. Generally, a fluid distribution apparatus includes multiple outlets that may be arranged as desired to control the pattern of fluid distribution. For example, outlets may be arranged in a regular and symmetric matrix to promote an even distribution of fluid over a given area or volume. In another example, a number of outlets may be concentrated in one location along the fluid distribution apparatus to provide varying concentration of fluids.

The fluid distribution apparatus will be described throughout this specification as articles with relatively complex shapes or geometries. Such descriptions will generally refer to an article that includes, for example, complex internal fluid paths, multiple internal fluid paths, outer dimensions with high aspect ratios, exterior or interior surfaces with non-planar or non-linear contours, or the like. Relatively complex shapes and geometries may also refer to articles with shapes and geometries that cannot be fabricated by directly machining the article from a block of material.

The fluid distribution apparatus will also be described throughout this specification as being formed from materials that are resistant to the corrosive or deteriorative nature of highly reactive materials, such as fluid aluminum. The apparatus handling and distributing fluid aluminum generally resist reacting with fluid aluminum, have heat resistant properties to handle the high temperatures of fluid aluminum, and must have sufficient density so that gaseous aluminum does not permeate through the apparatus itself. Forming the apparatus from materials that resist the corrosive and deteriorative nature of fluid aluminum substantially increases the service life of the fluid distribution apparatus for containing or distributing aluminum. Examples of such resistant materials include nitrides, carbides, carbonitrides, or oxynitrides of elements selected from the group of boron, aluminum, silicon, gallium, refractory hard metals, transition metals, and rare earth metals, or complexes or combinations of such materials.

In one embodiment, the fluid distribution apparatus are comprised substantially of pyrolytic boron nitride (pBN). Exemplary embodiments will generally be describe herein as comprising of pBN for convenience, and it will be understood by persons skilled in the art upon reading and understanding this specification that the fluid distribution apparatus are not limited to comprising pBN, but may be formed from any material that resists the corrosive and deteriorative nature of highly reactive materials.

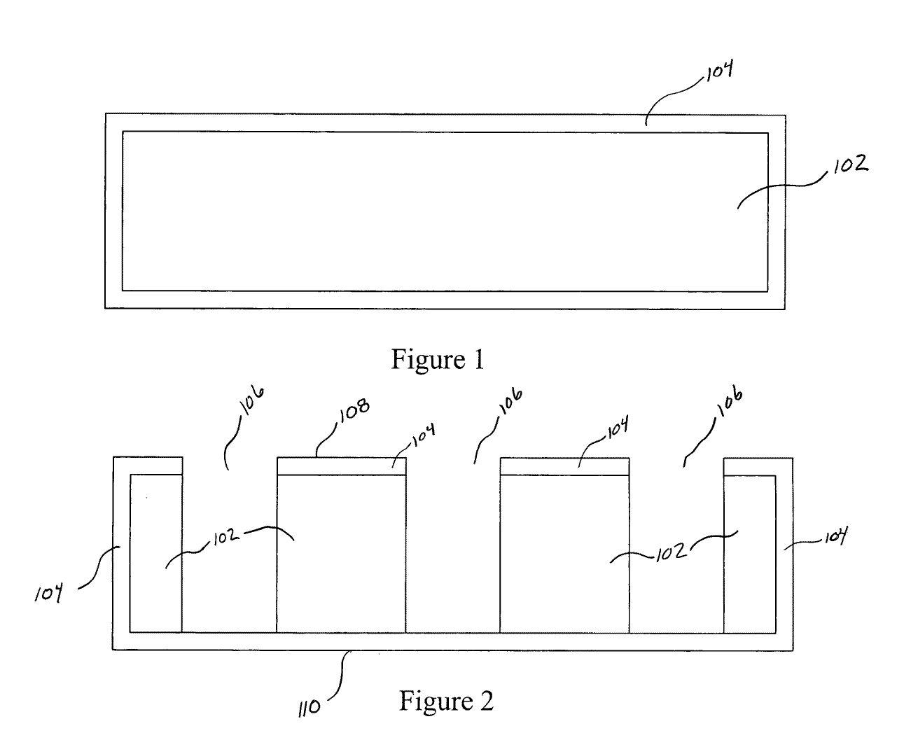

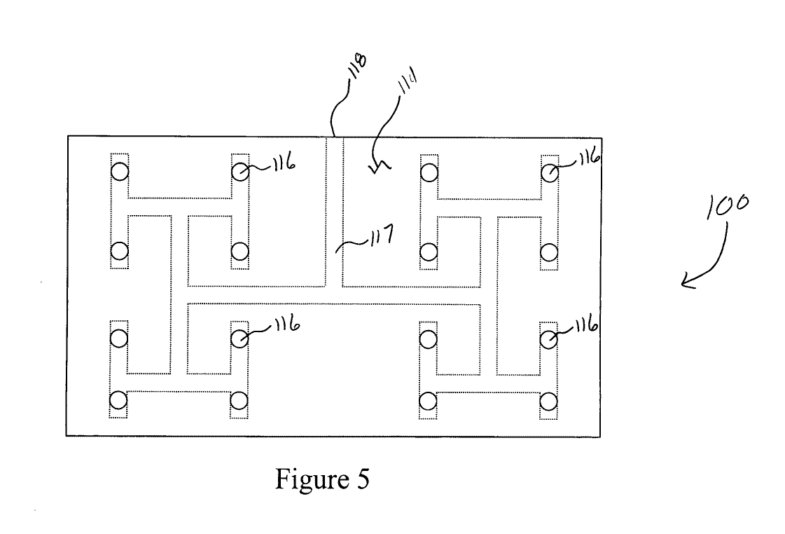

FIGS. 1 through 5 illustrate exemplary method steps for manufacturing, fabricating, forming, or otherwise providing a pBN fluid distribution apparatus 100. In particular, FIGS. 1 through 4 provide schematic cross-sectional views of the apparatus at different stages of fabrication. FIG. 5 provides a schematic bottom view of a completed fluid distribution apparatus 100. For convenience, the fluid distribution apparatus may be referred to as a “showerhead.”

As shown in FIG. 1, fabricating the fluid distribution apparatus 100 begins by providing a substrate 102 and coating external surfaces of the substrate 102 with a continuous layer 104 of pBN. The substrate 102 may be graphite or other such material. The substrate may be generally formed or machined into a variety of shapes such as a disc, cylinder, cube, rectangular box, custom shape, or the like. As will become apparent, the shape of the substrate generally is selected to facilitate the forming of the desired shape of the finished fluid distribution apparatus. For example, a disc-shaped substrate is typically used if the desired shape for a finished fluid distribution apparatus is disc-shaped.

The pBN layer 104 may be formed through a variety of methods. For example, the pBN layer may be deposited on the outer surfaces of the substrate through chemical vapor deposition, physical vapor deposition, atomic layer deposition, or the like. In the embodiment shown in FIG. 1, the pBN layer 104 forms a continuous coating on the external surface of the substrate 102 so as to encapsulate the substrate 102. As will be illustrated by other embodiments described herein, pBN layers instead may be arranged to coat selective surfaces of a substrate or selected locations on a selected surface.

Once the pBN layer 104 is deposited, one or more holes or grooves 106 may be formed through a top surface 108 of the pBN layer 104 and into the substrate 102. In one embodiment, shown in FIG. 2, a plurality of grooves 106 are mechanically formed through the top surface 108 of the pBN layer 104 and through the substrate 102 to the bottom surface 110 of the pBN layer 104. The forming of such grooves 106, particularly a relatively large number of grooves 106, can remove a substantial amount of the substrate material. Once the grooves 106 are formed, further mechanical processes may be performed to remove additional substrate material through the formed holes or grooves 106.

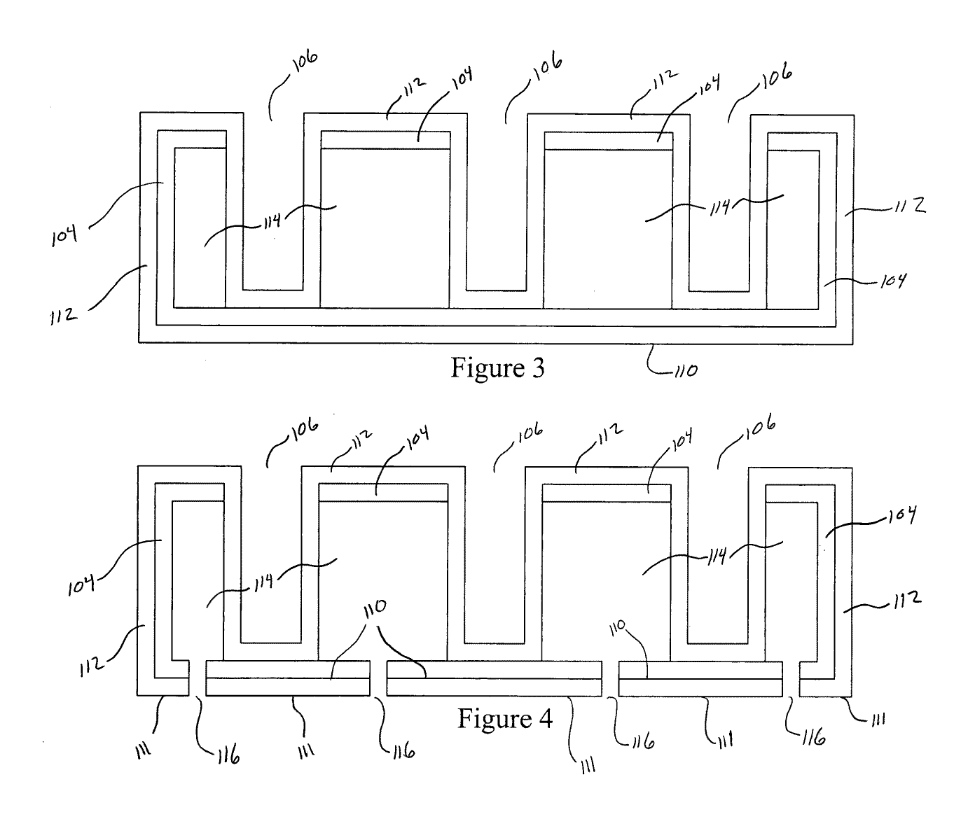

When the desired amount of substrate material is removed, a second layer 112 of pBN may be deposited or otherwise applied to the external surfaces of the partially-formed fluid distribution apparatus to form a second pBN layer 112 encapsulating the first pBN layer 104 and remaining substrate material of the partially-formed fluid distribution apparatus. FIG. 3 illustrates the results of such a step. A partially-formed fluid distribution apparatus is formed with pockets of substrate material 114 encapsulated by pBN layers 104, 112. A second set of holes 116 may be formed in the bottom surfaces 110, 111 of the first and second pBN layers 104, 112. The holes 116 provide access to the remaining substrate material 114 for its removal. In an embodiment, at least one hole 116 is formed through the bottom surfaces 110, 111 to provide access to each remaining pocket of substrate material 114. While holes 116 are formed to remove as much of the substrate material 114 as possible, it is contemplated that a person of ordinary skill in the art may choose not to form a hole 116 where a pocket of substrate material 114 is located so that some substrate material remains in a final fluid distribution apparatus (see, e.g. FIG. 20). The partially-formed fluid distribution apparatus is placed in an elevated temperature environment to remove the remaining substrate material 114 by oxidation or vaporization. The result is the fluid distribution apparatus 100 substantially comprised of pBN material. In one embodiment, the partially-formed fluid distribution apparatus may be heated to between 500 and 700 degrees Celsius, where the remaining substrate material 114 may oxidize or vaporize and exit the partially-formed fluid distribution apparatus through the formed holes 116.

FIG. 5 shows a bottom view of an exemplary fluid distribution apparatus 100 manufactured, fabricated, or otherwise formed by the method steps described above and shown in FIGS. 1 through 4. After substrate material 114 shown in FIGS. 3 and 4 is removed, a continuous fluid path or plenum 117 is formed within the pBN fluid distribution apparatus 100, as shown in FIG. 5. The fluid distribution apparatus 100 includes an inlet 118 formed through a surface of the apparatus 100 to provide access to the fluid path 117. Such access may be utilized to provide fluid to the plenum 117, evacuate fluid from the plenum 117, or provide pressure to the plenum 117. The series of holes 116 formed in the bottom surface 110 of the fluid distribution apparatus 100 may serve as outlets for fluid contained within the plenum 117. The apparatus distributes fluid through the outlets 116 when positive pressure is provided to the plenum 117. Providing controlled pressure to the plenum 117 allows for close control of fluid distribution through the outlets 116. Such an arrangement forms a useful fluid distribution apparatus 100 to distribute liquid, gas, or vapor in a variety of industrial applications.

It will be readily understood by persons of ordinary skill in the art upon reading and understanding this specification that the fabrication methods described herein may be designed to arrange a vast variety of configurations or arrangements for both the fluid distribution apparatus and its internal fluid paths. This flexibility makes it possible to arrange many desirable distribution patterns by designing the fluid paths or plenums and outlets to effectively distribute fluid in a desired pattern or manner.

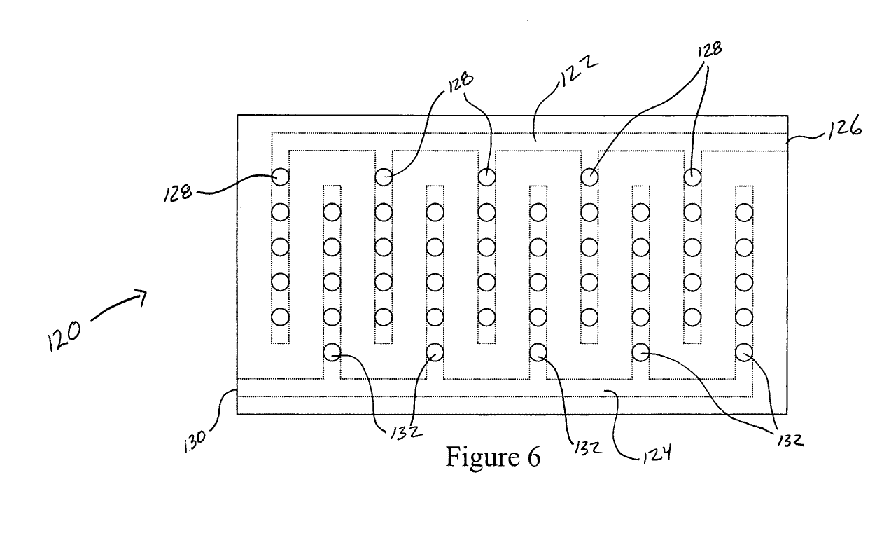

FIG. 6 shows another embodiment of an exemplary fluid distribution apparatus 120. Such an embodiment is fabricated generally as described above and shown in FIGS. 1 through 4; however, the resulting fluid distribution apparatus 120 is arranged to distribute two fluids instead of one fluid. The fluid distribution apparatus 120 is fabricated such that the substrate material that remains prior to the oxidizing step includes two distinct continuous patterns of material. Once the fluid distribution apparatus 120 is heated and the substrate material is removed, a first fluid path or plenum 122 and a second fluid path or plenum 124 are formed. The first plenum 122 includes a first inlet 126 and a first series of outlets 128 positioned to provide for the desired distribution of a first fluid. Similarly, the second plenum 124 includes a second inlet 130 and a second series of outlets 132 positioned to provide for the desired distribution of a second fluid. The first fluid may be provided to the first inlet 126 and may be distributed through the first series of outlets 128, and the second fluid may be provided to the second inlet 130 and may be distributed through the second series of outlets 132. Such an arrangement may distribute two distinct fluids in a variety of desired distribution patterns.

The first 122 and second 124 plenums as shown in FIG. 6 are isolated from each other. In such an arrangement, two fluids are physically separated from each other to prevent a reaction between the fluids within the apparatus 120. However, the reaction between the two fluids upon exiting outlets 132 may be beneficial for an industrial process. It will readily be understood that the fluid distribution apparatus 120 may be arranged so that the fluids are distributed to intermingle and react in a manner that benefits an industrial process.

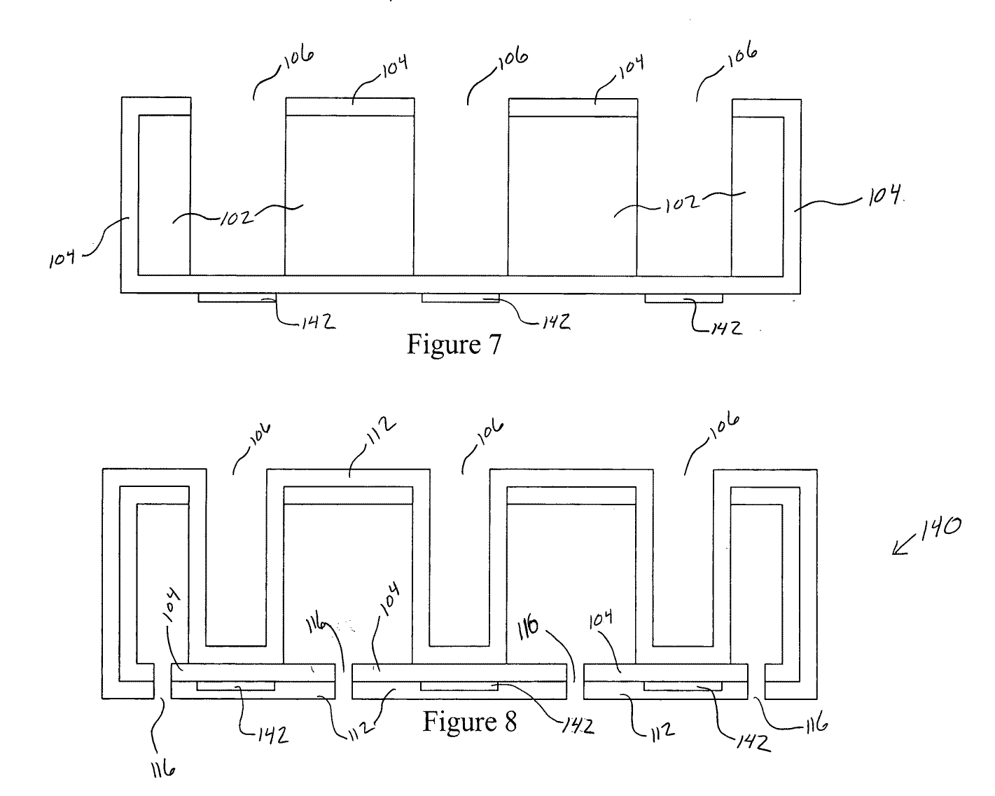

FIGS. 7 and 8 show a fluid distribution apparatus 140 that may be formed generally as described above and shown in FIGS. 1 and 4 but further include heating elements 142. After the first pBN layer 104 is deposited onto the substrate 102 and the holes or grooves 106 are formed, heating elements 142 are positioned on an outer surface of the first pBN layer 104, as shown in FIG. 7. The second pBN layer 112 may then be deposited over the partially-formed fluid distribution apparatus, and holes 116 may then be formed to access the remaining substrate material. When the partially-formed fluid distribution apparatus is placed in an elevated temperature environment to oxidize the remaining substrate material, the resulting fluid distribution apparatus 140 includes heater elements 142 positioned within the body of the pBN fluid distribution apparatus 140, as shown in FIG. 8. Such positioning of heating elements 142 may provide for greater control of the general temperature of the fluid distribution apparatus 140 and a more uniform heating pattern throughout the fluid distribution apparatus 140.

The heating elements may be arranged in any manner capable of producing heat through a connection to a power source. For example, the heating elements may be thin sheets of pyrolytic graphite, metal, or ceramic. In addition, the heating elements may be selectively distributed in a variety of arrangements to provide for uniform, distributed, or concentrated heating of the fluid distribution apparatus.

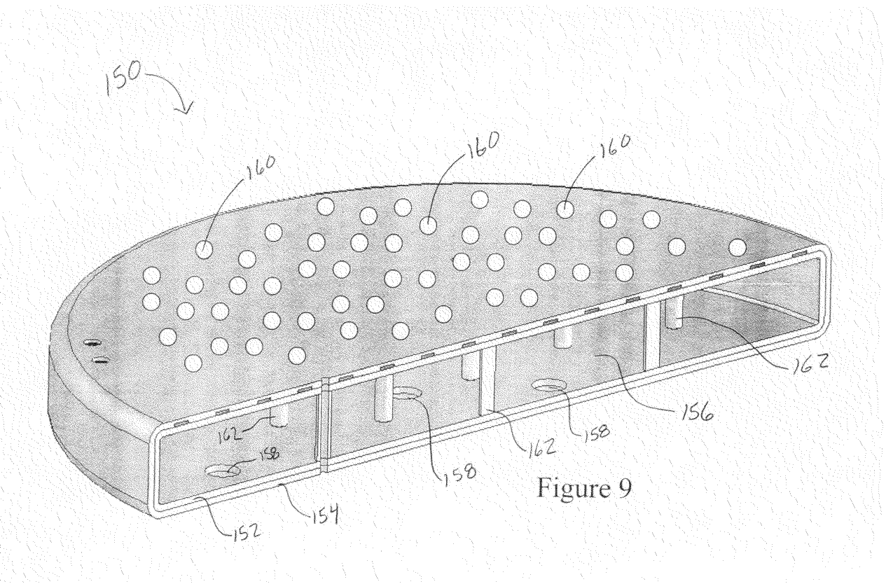

The described method allows for the forming of a variety of complex fluid distribution apparatus. For example, FIG. 9 illustrates a fluid distribution apparatus 150 with a complex shape and geometry. The fluid distribution apparatus 150 is fabricated from two pBN layers 152, 154 and includes a relatively large plenum 156, a series of inlets 158, a series of outlets 160, several pillars 162 positioned within the plenum 156 to add structural support to the fluid distribution apparatus 150, and several heating elements 164 positioned between the pBN layers 152, 154.

As will be understood, an exemplary process of fabricating such a fluid distribution apparatus 150 begins with a short cylindrical-shaped graphite substrate. The first pBN layer 152 is deposited onto the substrate. Heating elements 164 are positioned on the surface of the first pBN layer 152. A second pBN layer 154 is deposited onto the first pBN layer 152 and the heating elements 164. Holes are formed through one side of the pBN layers 152, 154 and through the substrate, and pBN material is deposited into the holes to form pillars 162. The inlets 158 and outlets 160 are formed through the pBN layers 152, 154 and substrate material is mechanically removed through the inlets 158 and outlets 160. The partially-formed fluid distribution apparatus is then placed in an elevated temperature environment and the remaining substrate material is oxidized or otherwise vaporized to form the fluid distribution apparatus 150.

The plurality of inlets 158 allows for multiple fluids to enter the plenum 156 and commingle before the fluids are distributed through the outlets 160. Alternatively, a common fluid may enter the plenum 156 through multiple inlets 158 so that pressure, density, or other such factors may be controlled in the plenum 156. Although multiple inlets 158 are illustrated, the fluid distribution apparatus may be fabricated with a single inlet to accommodate a single fluid.

The outlets 160 are shown in a generally regular pattern or matrix; however, the pattern of outlets 160 may vary widely to accommodate many desired fluid distribution patterns to serve a variety of industrial needs. The pillars 162 may be formed in a manner so that the pillars 162 are integrated with at least one of the pBN layers 152, 154. As shown in FIG. 9, the heating elements 164 are generally evenly distributed and positioned near the outlets 160. Such distribution and positioning of heating elements 164 allows for generally close control of the temperature of the fluid exiting the outlets 160. Although the heating elements 164 are shown as generally evenly distributed and positioned near the outlets 160, the distribution and positioning of heating elements can vary, or the fluid distribution apparatus can be formed without heating elements, depending on the application.

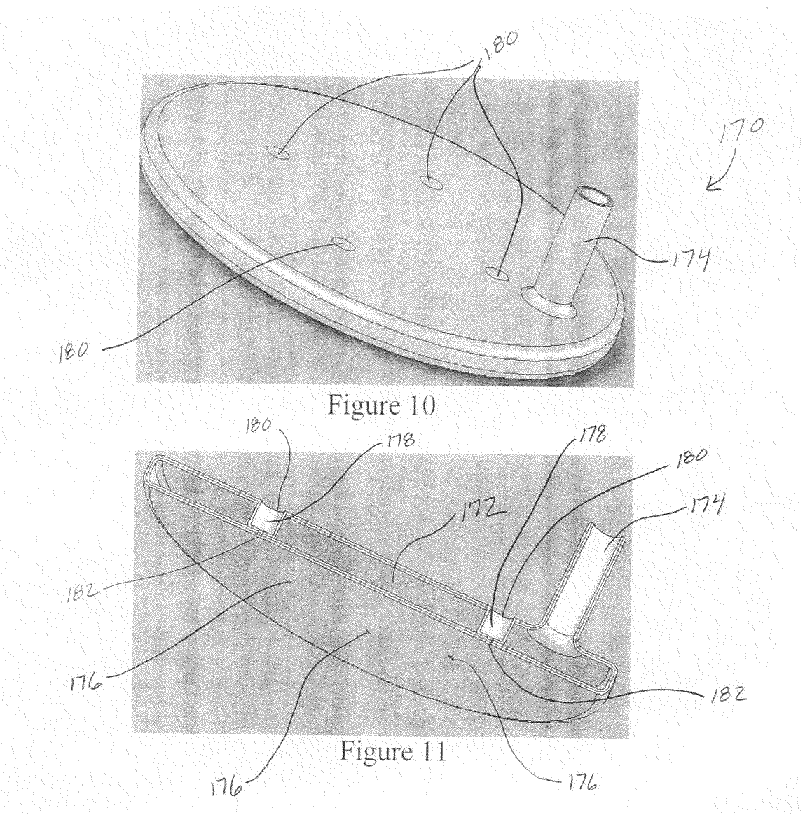

FIG. 10 and 11 illustrate another fluid distribution apparatus 170 embodiment with a complex shape and geometry. The fluid distribution apparatus 170 is similar to that illustrated in FIG. 9 in that it includes a large plenum 172 for containing a fluid. The fluid distribution apparatus 170 illustrated in FIGS. 10 and 11 further includes an integrated nozzle 174 to provide a fluid path to the plenum 172 and a convenient mechanism for connecting the plenum 172 to a fluid source. A first series of outlets 176 provide for the distribution of the fluid contained in the plenum 172. The fluid distribution apparatus 170 also includes a series of fluid passages 178 having an outlet 182. Each passage 178 is arranged so that it is not in fluid communication with the plenum 172 and may independently provide a fluid to the fluid distribution apparatus 170 for distribution. As illustrated, the inlets 180 for the passages 178 are generally located on the side of the fluid distribution apparatus 170 where the nozzle 174 is located, and the outlets 182 for the passages 178 are located on the same surface as the outlets 176 for the plenum 172.

The arrangement as shown in FIGS. 10 and 11 provides for a fluid distribution apparatus 170 that may distribute a first fluid through the nozzle 174, plenum 172, and plenum outlets 176 and a second fluid through the passages 178 and the corresponding outlets 182. The embodiment also provides for an arrangement where the same fluid is provided through the plenum 172 and the passages 178, but the fluid provided through the passages 178 is selectively controlled so as to manage the rate of the fluid distributed from the fluid distribution apparatus 170. It will be readily understood that each passage 178 may be arranged to be isolated from the plenum 172 and all other passages 178 so that the fluid distribution apparatus 170 may distribute multiple fluids. For example, if a fluid distribution apparatus 170 is arranged with one plenum 172 and three passages 178, four distinct fluids could be distributed.

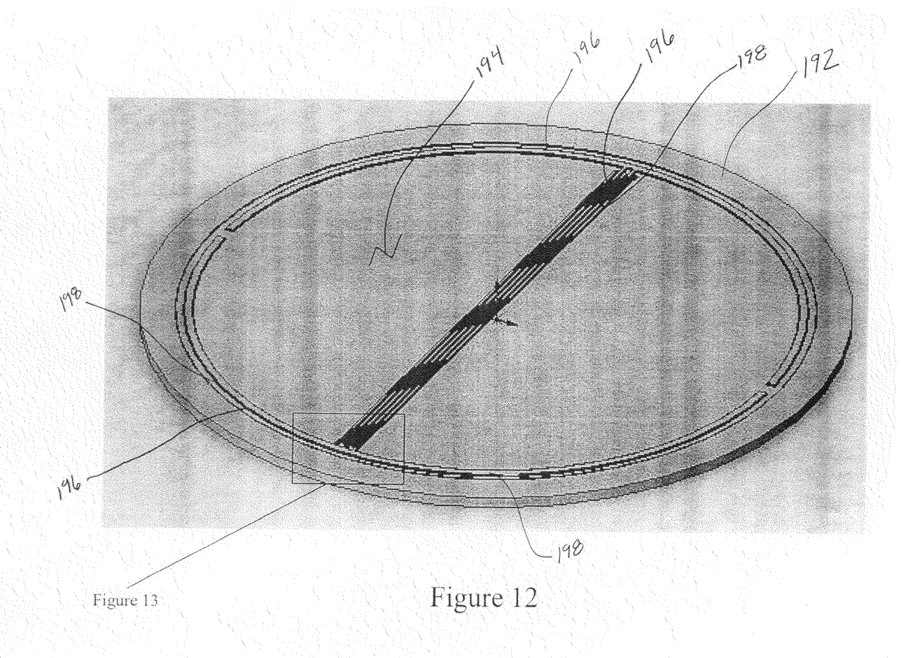

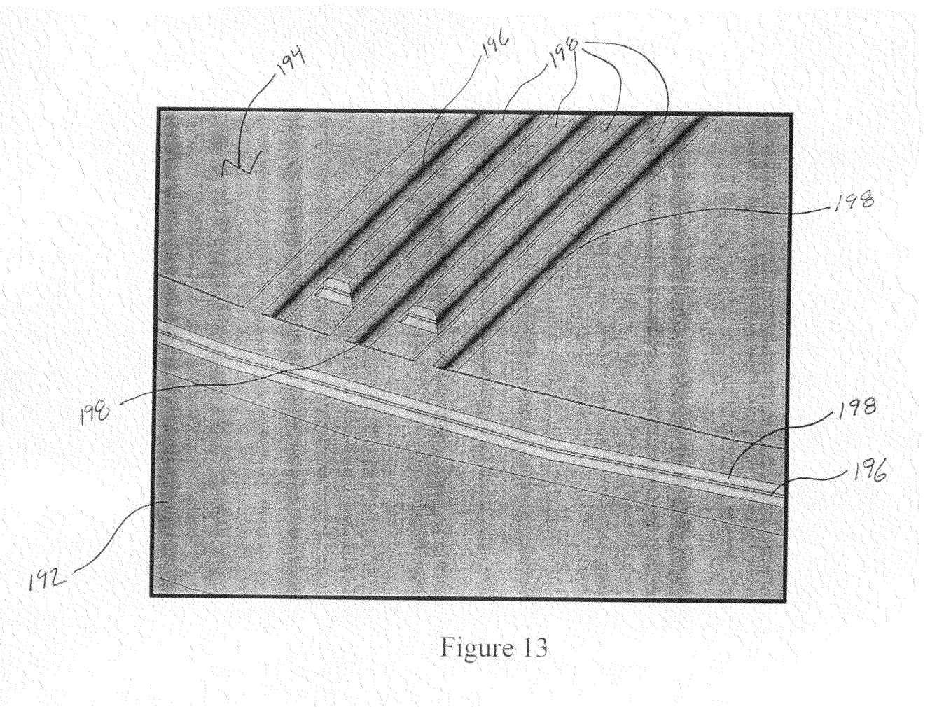

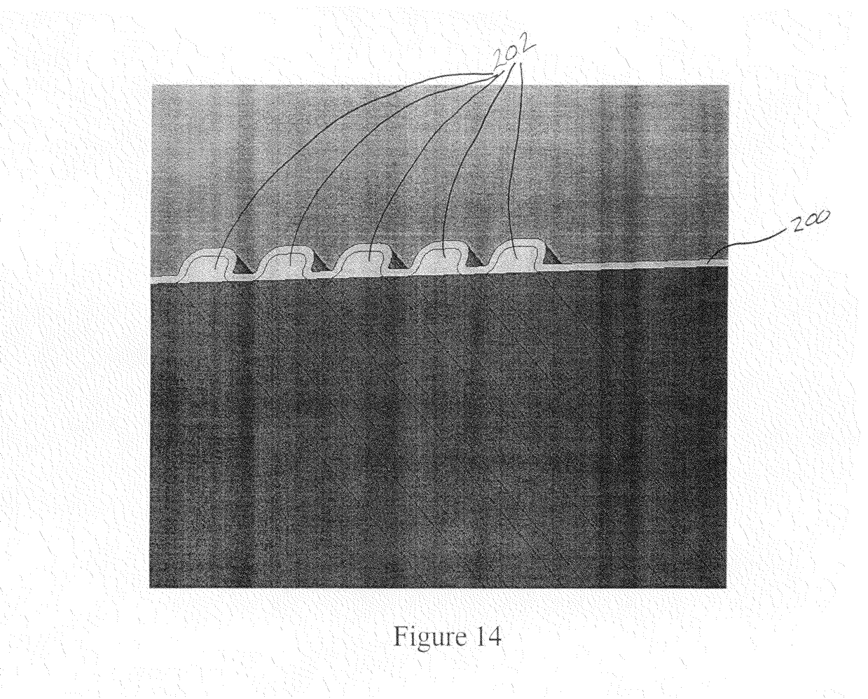

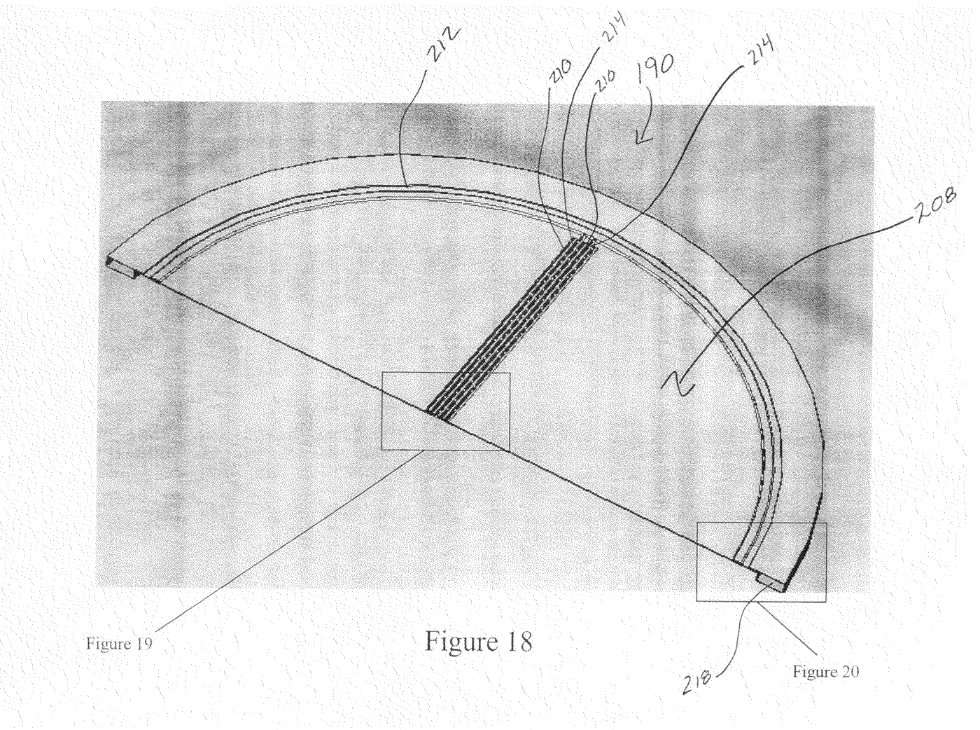

FIGS. 12 through 20 illustrate another fluid distribution apparatus 190 embodiment with a complex shape and geometry. The fluid distribution apparatus 190 includes fluid paths and outlets that form interdigitated plenums so multiple fluids can intermingle as they are distributed. The method for fabricating such a complex shape and geometry for a fluid distribution apparatus 190 is illustrated in FIGS. 12 through 16. The method begins with a substrate 192 of graphite or other such material. As shown in FIGS. 12 and 13, a top surface 194 of the substrate 192 may be machined to provide the surface 194 with a series of grooves 196. The grooves 196 may be machined so that the grooves 196 along with raised areas 198 adjacent to the machined grooves 196 form at least one continuous network. Once the top surface 194 of the substrate 192 is machined, a pBN layer 200 may be over-coated onto the top surface 194 of the machined substrate 192 to form a pBN layer 200 covering the network of grooves 196 and raised areas 198. The bottom surface of the machined substrate 192 is then machined to remove the majority of the substrate material, leaving only the pBN layer 200 coating the top surface 194 and pockets 202 of substrate material that formed the raised areas 198 on the top surface 194 of the substrate 192 (see FIG. 14).

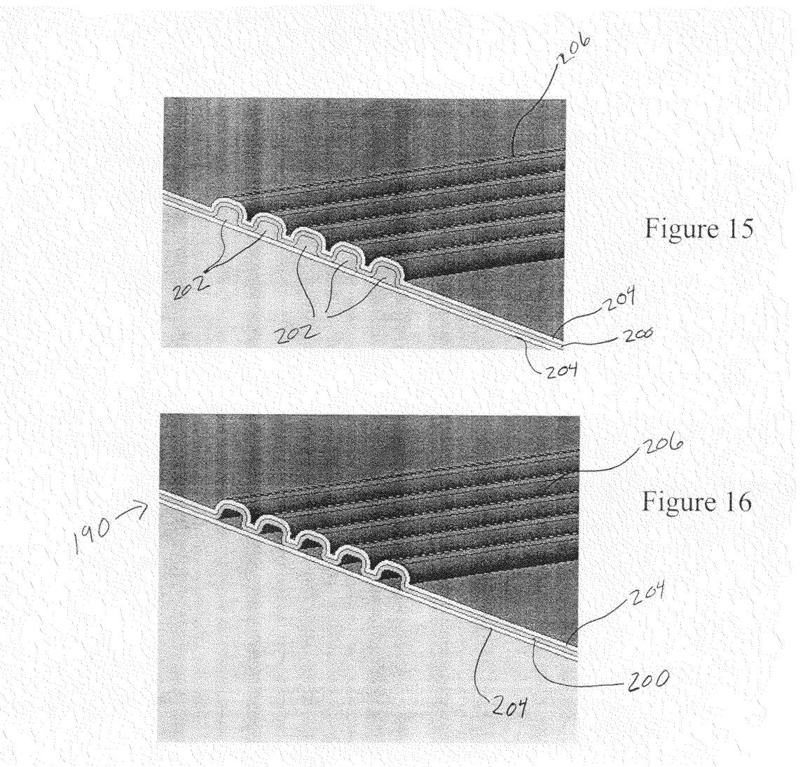

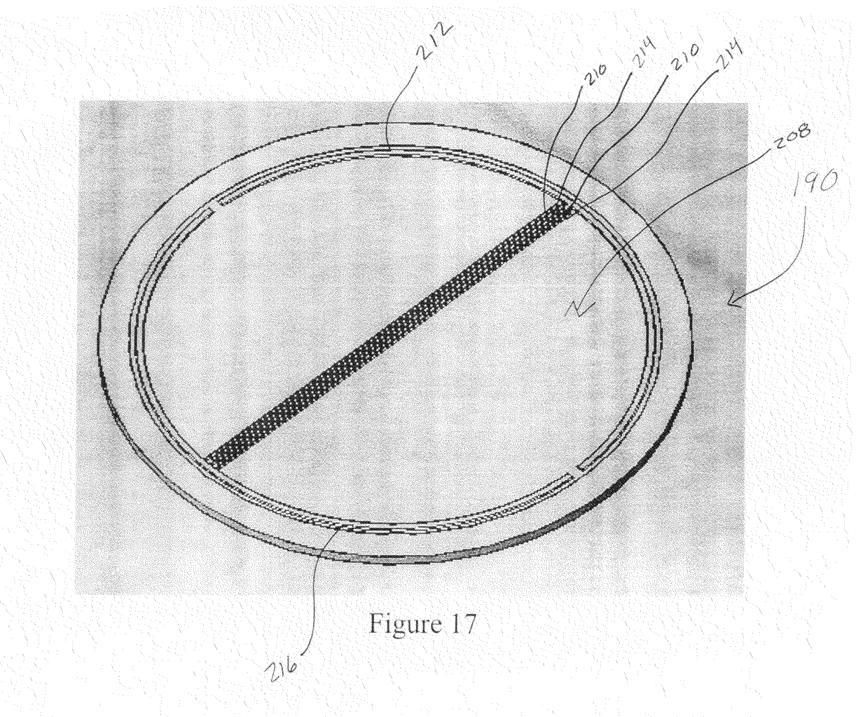

As shown in FIG. 15, a second layer of pBN 204 over coats the partially-formed fluid distribution apparatus to enclose the partially-formed apparatus in pBN. Outlets 206 are formed through the pBN layers 200, 204 to provide access to the pockets 202 of substrate material. The partially-formed fluid distribution apparatus is then placed in an elevated temperature environment, where the substrate material oxidizes and evacuates the partially-formed fluid distribution apparatus through the outlets 206. Once the oxidation process is completed, the resulting article is the pBN fluid distribution apparatus 190 with a complex shape and geometry as shown in FIGS. 17 through 20.

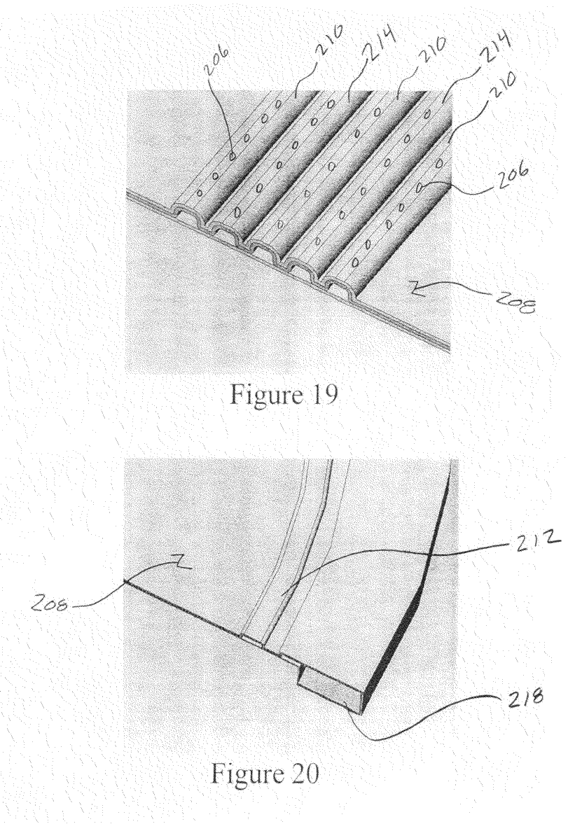

As best shown in FIGS. 19 and 20, the fluid distribution apparatus 190 includes interdigitated channels running along a top surface 208 of the fluid distribution apparatus 190 with series of outlets 206 to distribute the fluids passed through the fluid distribution apparatus 190 and a series of channels running around the perimeter of the top surface 208 of the fluid distribution apparatus 190. The channels may be arranged to form two independent fluid paths for the distribution of two fluids through the fluid distribution apparatus 190. A first fluid path may be comprised of a first set of alternating interdigitated channels 210 and a first set of channels 212 positioned along a first half of the perimeter of the fluid distribution apparatus 190. A second fluid path may be comprised of second set of alternating interdigitated channels 214 and a second set of channels 216 positioned along a second half of the perimeter of the fluid distribution apparatus 190. As will be understood, such an arrangement allows for two fluids to be distributed through the fluid distribution apparatus 190 and to intermingle as the fluids exit the outlets 206 of the fluid distribution apparatus 190. Inlets (not shown) may be positioned on the bottom surface of the fluid distribution apparatus 190 to provide fluid access to the fluid paths.

As is seen in FIG. 20, a ring 218 of substrate material may be left in place along the perimeter of the fluid distribution apparatus 190 to provide structural support for the fluid distribution apparatus 190. The ring 218 may be formed by encasing the substrate material in the first 200 and second 204 layers of pBN material without providing any holes or opening through which the substrate material may oxidize. Although the fluid distribution apparatus 190 is described and illustrated as including two fluid paths, it will be understood by persons of ordinary skill in the art upon reading and understanding this specification that any number of fluid paths may be arranged on such a fluid distribution apparatus. Any number of fluid paths may be formed by initially machining in the desired number of continuous networks into the substrate, applying layers of pBN, and oxidizing out the substrate material. It will also be understood that the fluid distribution apparatus 150 of FIG. 9, for example, may be adapted to include fluid paths as illustrated in FIGS. 12 through 20 on an exterior surface. Such an arrangement may provide for one large plenum that may distribute a relatively high volume of fluid and several smaller plenums that may distribute relatively low volumes of fluids. Such arrangements may be designed to apply to specific needs of industrial applications.

Fluid distribution apparatus may be fabricated into shapes and sizes that are difficult to form through conventional machining processes. For example, it may be difficult to machine a fluid distribution apparatus with elongated tubular sections or that have large aspect ratio. For example, a fluid distribution apparatus may have an elongated tubular section with a series of outlet holes to distribute fluid in a line over a relatively wide area. In another example, a fluid distribution apparatus may include a number of arms or extensions extending from a central body to distribute fluid in any desired pattern or over any desired area.

Such a fluid distribution apparatus may be fabricated with the methods or processes described herein. For example, a graphite substrate may be machined in a general shape desired. A pBN layer may be deposited over the substrate. Outlet and inlet holes may be formed and the partially-formed fluid distribution apparatus may be placed in an elevated temperature environment to oxidize and evacuate the graphite substrate material, resulting in a fluid distribution apparatus. In another embodiment heating elements may be included in the fluid distribution apparatus. Once the first pBN layer is deposited, heating elements may be positioned on the surface of the first pBN layer and a second pBN layer may be deposited, thus securing the heating elements within the pBN fluid distribution apparatus. Such heating elements may be utilized to maintain a controlled temperature within the fluid distribution apparatus, which may facilitate the deposition of the fluid contained within the fluid distribution apparatus.

The fluid distribution apparatus as described may be utilized to deposit a layer of aluminum on metal sheeting. For example, aluminum gas or vapors may be contained in the fluid distribution apparatus, which may be positioned above a conveyer system that moves long sheets of metal past the fluid distribution apparatus. The fluid distribution apparatus may be positioned such that outlets are located proximate to the moving metal sheet. When the fluid distribution apparatus is pressurized, aluminum vapor is distributed from the outlets and is deposited onto the metal sheet, forming an aluminum layer or film. The fluid distribution apparatus may be configured to have a relatively large width, such as a meter or more, so that the single fluid distribution apparatus may be utilized to coat metal sheeting that is a meter or more in width.

Embodiments of the invention have been described above and, obviously, modifications and alterations will occur to others upon the reading and understanding of this specification. The claims as follows are intended to include all modifications and alterations insofar as they come within the scope of the claims or the equivalent thereof.

What is claimed is:

1. A fluid distribution apparatus comprising:
a body comprising:
at least one of a nitride, carbide, carbonitride, oxynitride of elements comprising boron, aluminum, silicon, gallium, refractory hard metals, transition metals, and rare earth metals, or complexes or combinations thereof;
a first plenum positioned within the body;
a first inlet passing through a first portion of the body and in fluid communication with the first plenum; and
a first outlet passing through a second portion of the body and in fluid communication with the first plenum.

2. The fluid distribution apparatus of claim 1, where the body is comprised of pyrolytic boron nitride.

3. The fluid distribution apparatus of claim 2, where the body includes a first pyrolytic boron nitride layer and a second pyrolytic boron nitride layer deposited onto the first pyrolytic boron nitride layer.

4. The fluid distribution apparatus of claim 3, further comprising a heating element positioned between the first pyrolytic boron nitride layer and the second pyrolytic boron nitride layer.

5. The fluid distribution apparatus of claim 1, where the first outlet is one of a plurality of outlets distributed along an external surface of the body.

6. The fluid distribution apparatus of claim 1, where the first inlet is one of a plurality of inlets distributed along an external surface of the body.

7. The fluid distribution apparatus of claim 1, where the body further comprises a second plenum positioned within the body, a second inlet passing through a third portion of the body and in fluid communication with the second plenum; and a second outlet passing through a fourth portion of the body and in fluid communication with the second plenum.

8. The fluid distribution apparatus of claim 7, where the first plenum includes a first plurality of interdigitated channels and the second plenum includes a second plurality of interdigitated channels alternatingly positioned with the first plurality of interdigitated channels.

9. The fluid distribution apparatus of claim 8, where the first outlet is one of a plurality of outlets, each outlet in fluid communication with one of the first plurality of interdigitated channels; and the second outlet is one of a plurality of outlets, each outlet in fluid communication with one of the second plurality of interdigitated channels.

10. The fluid distribution apparatus of claim 1, where the body has a high aspect ratio.

11. The fluid distribution apparatus of claim 10, further comprising a heating element positioned within a wall of the body.

12. The fluid distribution apparatus of claim 1, where the body is disc-shaped.

13. A method for forming a fluid distribution apparatus comprising:
providing a substrate;
depositing a first layer onto the substrate, the layer comprising at least one of a nitride, carbide, carbonitride, oxynitride of elements selected from the group of boron, aluminum, silicon, gallium, refractory hard metals, transition metals, and rare earth metals, or complexes or combinations thereof;
forming at least one hole through at least a portion of the first layer and substrate;
depositing a second layer onto at least a portion of the remaining first layer and onto at least a portion of exposed substrate;
forming at least one hole through the first and second layers to provide fluid access to the substrate; and
removing substrate material from the hole by elevating the environmental temperature, whereby a fluid distribution apparatus is formed.

14. The method of claim 13, wherein the removing step provides a first plenum positioned within the first and second layers.

15. The method of claim 14, further comprising the step of providing a first inlet and a first outlet in fluid communication with the first plenum.

16. The method of claim 15, further comprising the step of providing a second plenum positioned within the first and second layers, a second inlet and a second outlet in fluid communication with the second plenum.

17. The method of claim 13, further comprising the step of placing a heating element on the first layer prior to the deposition of the second layer.

18. The method of claim 13, where the first layer comprises pyrolytic boron nitride.

19. The method of claim 13, where the second layer comprises pyrolytic boron nitride.

20. The method of claim 13, where the second layer is comprised of substantially the same material as the first layer.
